(19) United States
(12) Patent Application Publication
(10) Pub. No.: US 2011/0075215 A1
(43) Pub. Date: Mar. 31, 2011

(54) INFORMATION PROCESSING APPARATUS CAPABLE OF PRINTING DYNAMIC OBJECTS, METHOD OF CONTROLLING THE SAME, AND STORAGE MEDIUM

(75) Inventor: Hiroshi Kikuchi, Musashino-shi (JP)

(73) Assignee: CANON KABUSHIKI KAISHA, Tokyo (JP)

(21) Appl. No.: 12/892,596

(22) Filed: Sep. 28, 2010

(30) Foreign Application Priority Data
Sep. 30, 2009 (JP) 2009-227129

(51) Int. Cl. G06F 3/12

(52) U.S. Cl. 358/1.15

(57) ABSTRACT

An information processing apparatus which is capable of easily designating respective moments desired for printing in the case of printing a plurality of dynamic objects each requiring a plug-in. The CPU of the information processing apparatus gives an instruction, to each of a plurality of dynamic objects contained in a displayed Web page, for specifying an image of a dynamic object in predetermined timing. The designated image in the predetermined timing is stored on a dynamic object basis for each of the dynamic objects, and print data for printing the Web page is generated using the images stored as print images associated with the respective dynamic objects.

### BACKGROUND OF THE INVENTION

1. Field of the Invention

The present invention relates to an information processing apparatus, a method of controlling the information processing apparatus, and a non-transitory computer-readable storage medium storing a program for causing a computer to execute the method, and more particularly to an information processing apparatus which is characterized by a function of browsing a Web page containing moving images or interactive contents, such as FLASH (registered trademark) contents or Java (registered trademark) contents, a method of controlling the information processing apparatus, and a non-transitory computer-readable storage medium storing a computer-executable program for causing a computer to execute the method.

2. Description of the Related Art

The Web-page technique is experiencing evolution on a daily basis, and an increasing number of Web pages contain dynamic objects provided by moving images or FLASH (registered trademark) or Java (registered trademark). In most cases, the dynamic objects are created such that they operate on programs called “plug-ins”, which are different from a Web browser.

A plug-in is a module which is capable of dynamically adding or updating functions for a Web browser. When a plug-in is added, it is possible to define a new behavior associated with an object without changing the source of the Web browser. In a Web browser having an interface for plug-in creation open to the public, non-genuine plug-ins created by other than a Web browser maker are also widely used.

FIG. 11 is a view of a layout of a general Web browser.

The Web browser 10 includes a toolbar area 1006 provided with a return button 1001, an advance button 1002, a read stop button 1003, a re-read button 1004, a print button 1005, and so forth. Actual Web contents are loaded and displayed in a view area 1007.

The view area 1007 has a scroll bar 1008 provided therefor. Objects which cannot be contained within the view area 1007 can be browsed by scrolling the scroll bar 1008 by operating a mouse.

FIG. 11 illustrates a case in which three dynamic objects 1010, 1011, and 1012 are laid out in the view area 1007 of the Web browser 10. In each of these areas, image display, mouse event processing, and so forth are managed by such plug-ins as mentioned above.

On the other hand, the dynamic objects are designed basically for browsing on a display, and hence in most cases, they cannot be printed as intended.

FIG. 12 illustrates a case in which printing is performed on a sheet, using the print button 1005 appearing in FIG. 11.

As shown in a printout 1110, the dynamic object 1010 is printed in a hollowed form, whereas as shown in a printout 1111, the dynamic object 1011 is printed in solid black. Further, as shown in a printout 1112, the dynamic object 1012 is printed in a half-finished state not desired by the user.

As described above, a printout of an area displayed by a plug-in depends on the implementation of the plug-in, which makes it difficult to print an instantaneous image as intended by the user. In order to print an instantaneous image as intended by the user, a method can be envisaged in which the user takes a capture of the screen and prints the same.

However, what can be captured is only an image of a portion that fits into the display screen at a time, as shown in FIG. 13, and hence the printout depends on the size of a window, which causes degradation of userfriendliness.

To solve the above problems, there has been proposed a technique of presenting still images captured from a moving image contained in contents at respective several times designated by the user, and enabling the user to print one of the still images selected by the user (see Japanese Patent Laid-Open Publication No. 2000-181924).

However, in the technique proposed in Japanese Patent Laid-Open Publication No. 2000-181924, in order to capture a still image from a moving image, it is required to preset parameters for use in capturing the still image. For this reason, it is difficult to realize the technique when a user desires to print an instantaneous image which is captured from an interactive content operating in accordance with user response or an online game content or the like which is changing on a real-time basis.

Further, in printing contents requiring a plurality of plug-ins as shown in FIG. 11, it is desirable to print respective instantaneous images desired from the contents, but a very complicated operation is needed to configure settings of the plug-ins for the purpose of capturing from the respective contents.

### SUMMARY OF THE INVENTION

The present invention provides an information processing apparatus which is capable of easily designating respective moments desired for printing in the case of printing a plurality of dynamic objects each requiring a plug-in, a method of controlling the information processing apparatus, and a non-transitory computer-readable storage medium storing a program for causing a computer to executed the method.

In a first aspect of the present invention, there is provided a information processing apparatus comprising an instruction unit configured to give an instruction, to each dynamic object of a plurality of dynamic objects contained in a displayed Web page, for specifying an image of the dynamic object in predetermined timing, a storage unit configured to store the specified image of the dynamic object in the predetermined timing, on a dynamic object basis for each of the plurality of dynamic objects, and a generation unit configured to generate, when executing printing of the Web page, print data using the images stored by the storage unit without using images being displayed during execution of the printing as print images associated with the respective dynamic objects.

In a second aspect of the present invention, there is provided a method of controlling an information processing apparatus, comprising giving an instruction, to each dynamic object of a plurality of dynamic objects contained in a displayed Web page, for specifying an image of the dynamic object in predetermined timing, storing the specified image of the dynamic object in the predetermined timing, on a dynamic object basis for each of the plurality of dynamic objects, and generating, when executing printing of the Web page, print data using the stored images without using images being displayed during execution of the printing as print images associated with the respective dynamic objects.

In a third aspect of the present invention, there is provided a non-transitory computer-readable storage medium storing a computer-executable program for causing a computer to execute a method of controlling an information processing apparatus, wherein the method comprises giving an instruction, to each dynamic object of a plurality of dynamic objects contained in a displayed Web page, for specifying an image of the dynamic object in predetermined timing, storing the specified image of the dynamic object in the predetermined timing, on a dynamic object basis for each of the plurality of dynamic objects, and generating, when executing printing of the Web page, print data using the stored images without using images being displayed during execution of the printing as print images associated with the respective dynamic objects.

According to the present invention, in the case of printing dynamic objects each requiring a plug-in, it is possible to easily designate respective moments desired for printing.

Further features of the present invention will become apparent from the following description of exemplary embodiments with reference to the attached drawings.

### BRIEF DESCRIPTION OF THE DRAWINGS

FIG. 1 is a configuration diagram of an entire system including an external environment of an information processing apparatus according to an embodiment of the present invention.

FIG. 2 is a block diagram showing the internal configuration of a computer appearing in FIG. 1.

FIG. 3 is a flowchart of an object layout process executed by a page display section appearing in FIG. 1, so as to lay out objects in a view area of a Web browser.

FIG. 4 is a view of an example of object layout in the view area after execution of the object layout process in FIG. 3 by the page display section.

FIG. 5 is a diagram of an example of a plug-in management database for use in the object layout process in FIG. 3.

FIG. 6 is a flowchart of an event process in which an input controller appearing in FIG. 1 operates.

FIG. 7 is a diagram of an example of a capture object database for use in the object layout process in FIG. 3.

FIG. 8 is a flowchart of a print process executed by the computer appearing in FIG. 1.

FIG. 9 is a flowchart of a page rendering process executed in the FIG. 8 print process.

FIG. 10 is a view of an example of a printout from a Web browser appearing in FIG. 1.

FIG. 11 is a view of a layout of a general Web browser.

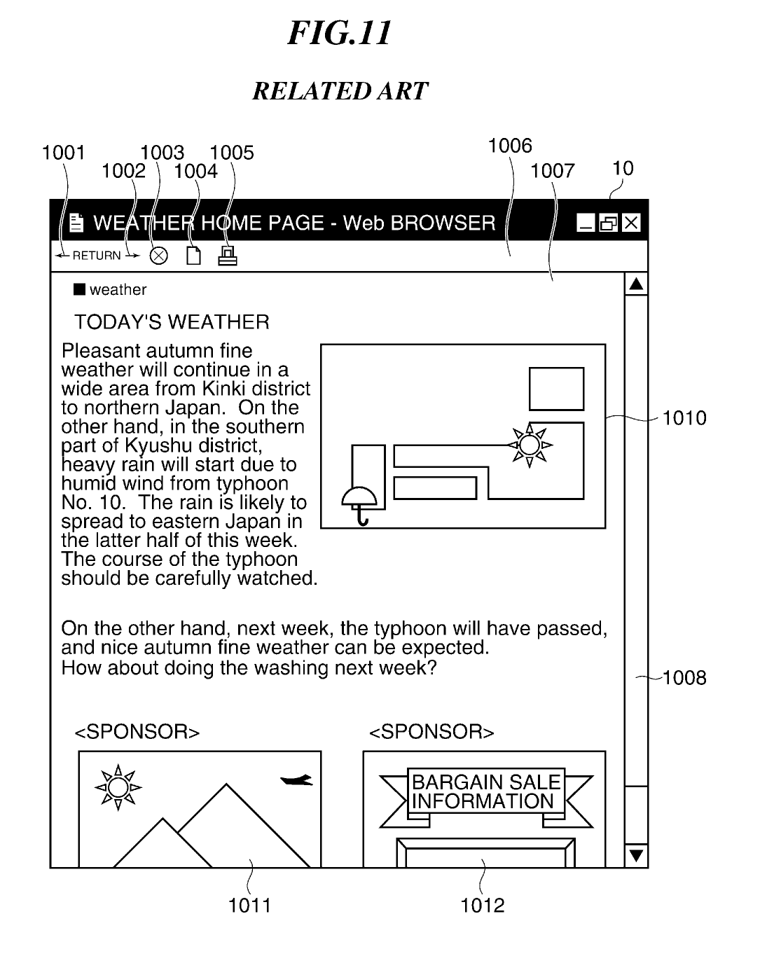

FIG. 12 is a view showing a first example of unsuccessful printing of a Web page.

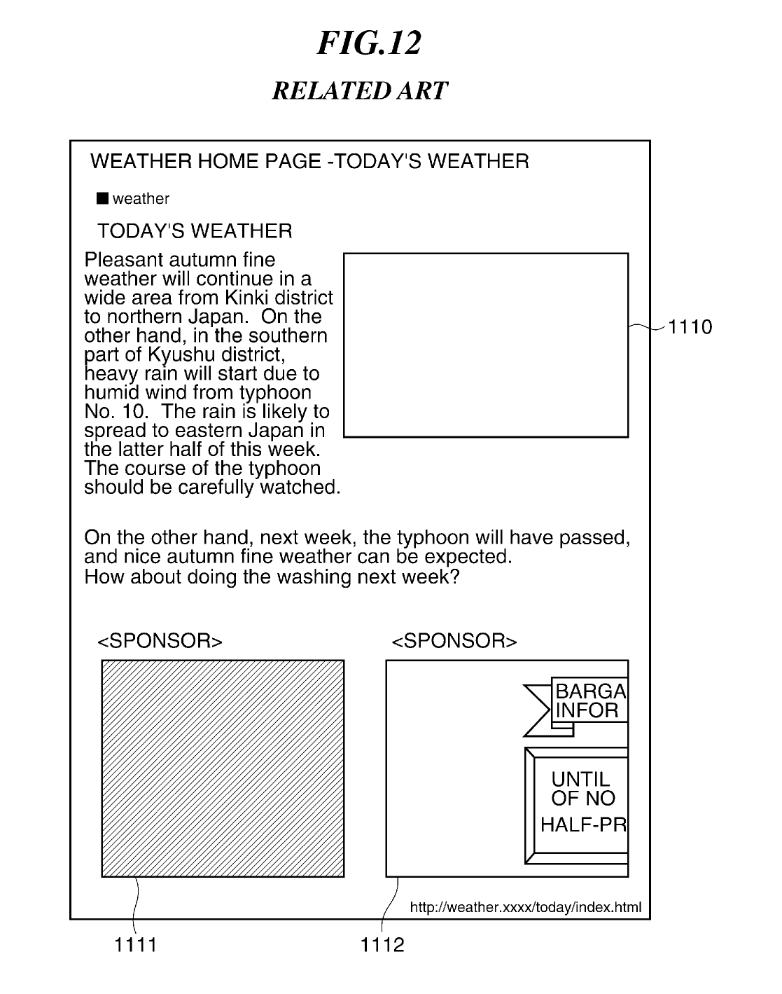

FIG. 13 is a view showing a second example of unsuccessful printing of the Web page.

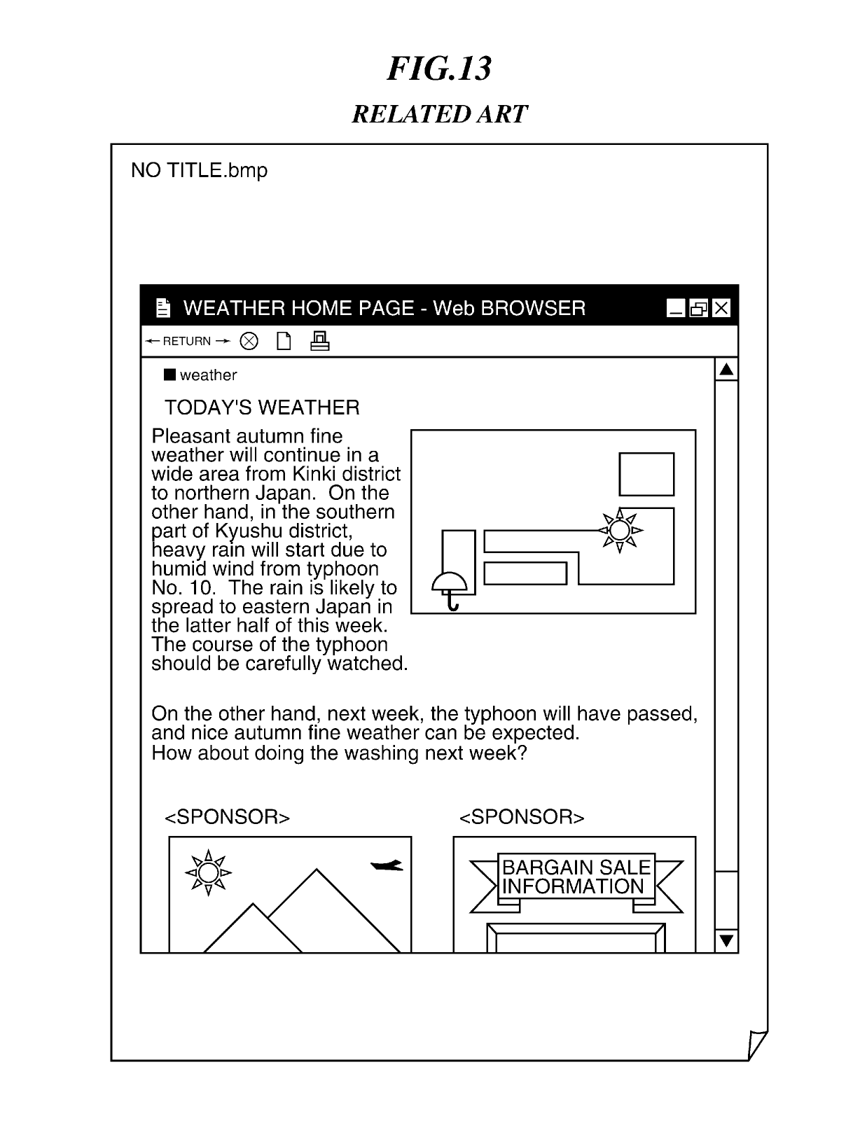

### DETAILED DESCRIPTION OF THE EMBODIMENTS

The present invention will now be described in detail below with reference to the accompanying drawings showing an embodiment thereof.

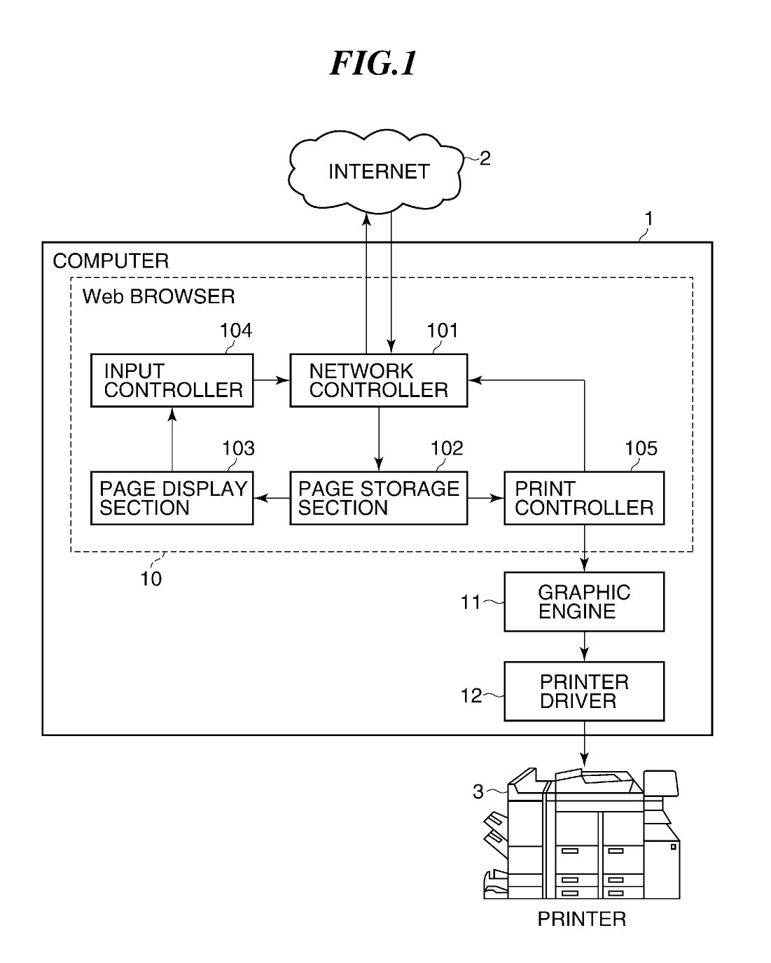

FIG. 1 is a configuration diagram of an entire system including an external environment of an information processing apparatus according to the embodiment of the present invention.

As shown in FIG. 1, a computer 1 implementing the information processing apparatus is connected to the Internet 2 and a printer 3 via a network interface, such as Ethernet (registered trademark).

In the computer 1, a Web browser 10 operates as an application on an operating system (OS). A network controller 101 as a component of the Web browser 10 performs processing e.g. for acquiring Web contents from the Internet 2.

A page storage section 102 functioning as another internal component of the Web browser 10 stores Web contents acquired by the network controller 101 in a storage device, such as a memory or a hard disk, or retrieves ones of the stored Web contents from the storage device in response to a request from an external component. A page display section 103 performs processing for retrieving a Web page stored by the page storage section 102, interpreting HTML description, and displaying the Web page on a screen.

Next, an input controller 104 detects a menu command of the Web browser 10 and an input via a link or a button displayed in a Web page, and performs processing associated with the menu command or the input. For example, when an operation of clicking a link in a Web page is detected, the input controller 104 instructs the network controller 101 to acquire a linked Web page.

A print controller 105 is a component that performs processing for displaying a print preview of a Web page, changing the layout of the Web page, printing the Web page, and so forth.

A graphic engine 11 is a component that controls rendering processing by the operating system, and plays the role of transferring a rendering command from the print controller 105. A printer driver 12 is software that receives the rendering command transferred from the graphic engine 11, as an input, and converts the command to PDL data interpretable by the printer 3 to deliver the PDL data as an output.

The printer 3 receives the PDL data from the printer driver 12 via the network and prints out the same. Although in the present embodiment, the printer 3 is implemented by a digital multifunction peripheral connected to the computer 1 e.g. by Ethernet (registered trademark), this is not limitative, but the printer 3 may be implemented e.g. by an inkjet printer connected to the computer 1 by a USB interface.

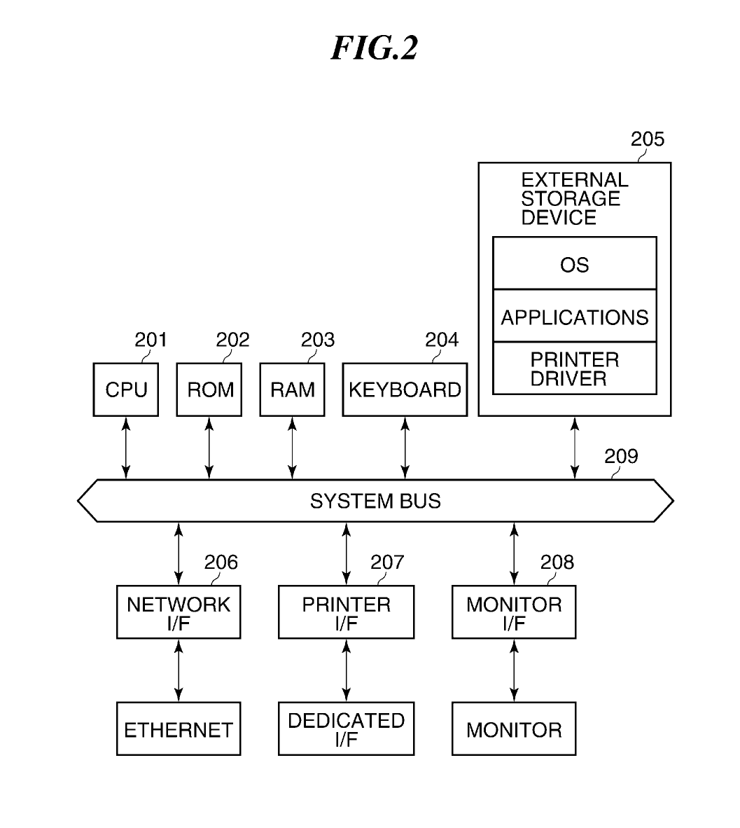

FIG. 2 is a block diagram showing the internal configuration of the computer 1 appearing in FIG. 1.

A CPU 201 controls the overall operation of the apparatus according to programs stored in a ROM 202, a RAM 203, and an external storage device 205. The CPU 201 uses the RAM 203 as a work area for carrying out various processes.

The external storage device 205 stores the operating system (OS), application software, printer driver software, etc. A keyboard 204 or an input device, such as a mouse, not shown, is used for a user to give various instructions.

A network interface (I/F) 206 and a printer interface (I/F) 207 are connected to the printer 3 via by Ethernet (registered trademark) or a dedicated interface, for data transmission and receipt. A monitor interface (I/F) 208 is connected to a monitor, for transfer of display data. A system bus 209 functions as a common data bus.

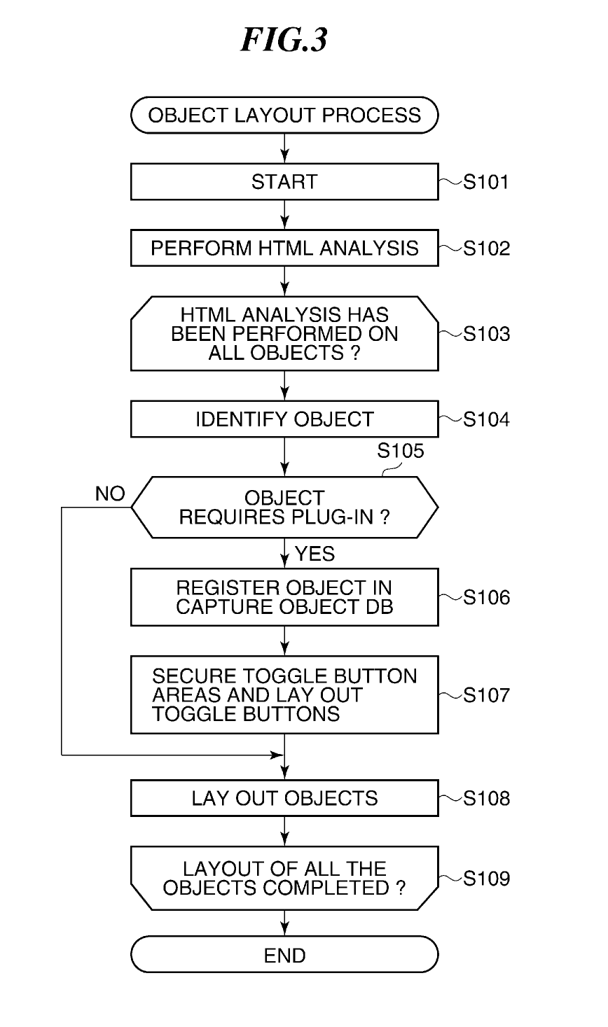

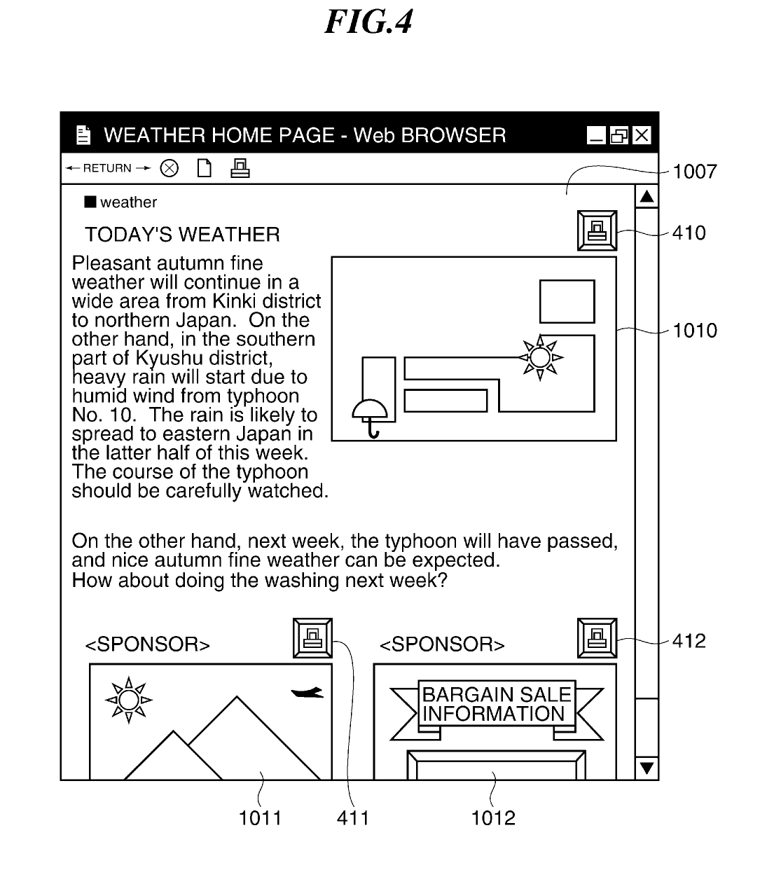

FIG. 3 is a flowchart of an object layout process executed by the page display section 103 appearing in FIG. 1, so as to lay out objects in a view area 1007 (see in FIG. 4) of the Web browser 10.

First, the process starts in a step S101, and then in a step S102, the CPU 201 (Web browser 10) analyzes an HTML document retrieved from the page storage section 102. In the step S102, the grammar of the HTML language is interpreted, and all existing rendering objects (buttons) are converted to a format that can be managed by the page display section 103, followed by being stored in the RAM 203.

After the HTML analysis is performed on all the rendering objects (step S103), the process proceeds to a step S104, wherein the CPU 201 identifies a rendering object. Then, in a step S105, the CPU 201 determines whether or not the rendering object requires a plug-in.

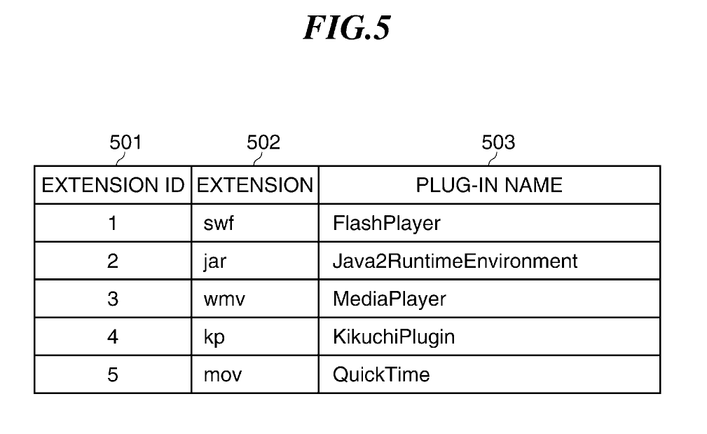

This determination is performed using e.g. a plug-in management database (DB) described hereinafter with reference to FIG. 5. If the object does not require a plug-in, the process proceeds to a step S108, wherein the CPU 201 performs layout of the object.

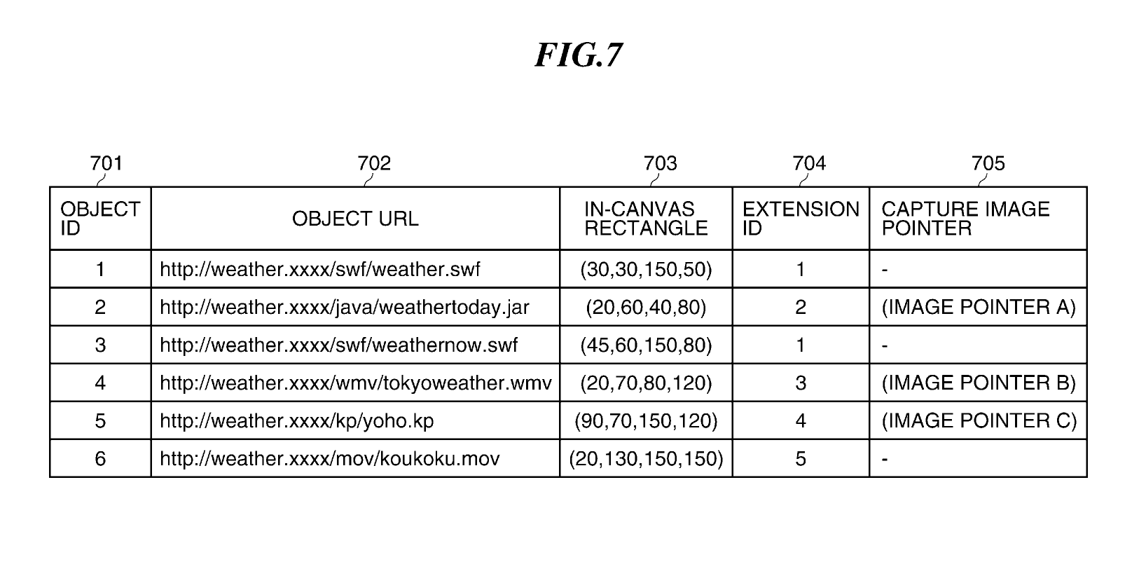

On the other hand, if the object requires a plug-in, the process proceeds to a step S106, wherein the CPU 201 registers the object in a capture object database (DB). The capture object database will be described hereinafter with reference to FIG. 7.

Then, in a step S107, for layout of display of the Web page, the CPU 201 secures a toggle button area close to each dynamic object and performs layout of toggle buttons (capture button). Then, in the step S108, the CPU 201 lays out the objects each requiring a plug-in.

By executing the steps S107 and S108, the toggle buttons are positioned in the view area 1007 in the Web browser 10 at locations in the vicinity of the respective objects each requiring a plug-in. When layout of all the objects is completed (step S109), the present process is terminated.

FIG. 4 is a view of an example of object layout in the view area 1007 after execution of the object layout process in FIG. 3 by the page display section 103.

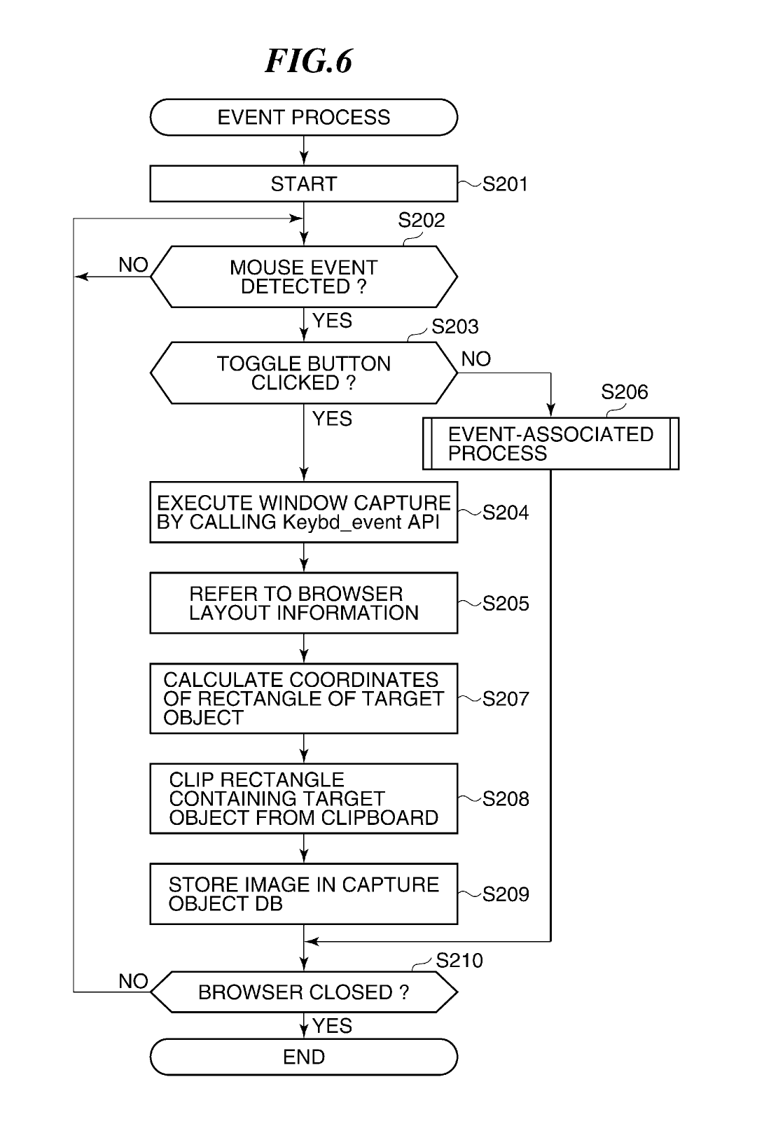

Toggle buttons 410 to 412 are provided in the vicinity of respective dynamic objects 1010 to 1012 each determined as requiring a plug-in based on the HTML interpretation. This enables the user to press a toggle button at a moment desired for printing of each object that changes with time. A process executed after depression of a toggle button will be described hereinafter with reference to FIG. 6.

FIG. 5 is a diagram of an example of the plug-in management database for use in the step S105 in FIG. 3.

The plug-in management database, in which plug-in names 503 are associated with extensions 502 assigned to respective files linked as Web contents, is stored in the external storage device 205. Each of the extensions 502 is managed based on an extension ID 501.

A plug-in is a module that can be dynamically added to the Web browser 10, as described hereinbefore. When a new plug-in is added, an associated extension ID is added to the plug-in management database, whereby the plug-in management database is updated.

It should be noted that the plug-in management database manages only plug-ins that can be displayed in the view area 1007 and enables event management. Although in the present example, a case where extensions are associated with respective plug-ins for management is shown for simplicity of explanation, the present invention can be also applied to cases where plug-ins are each identified based on other information acquired from HTML tags.

FIG. 6 is a flowchart of an event process in which the input controller 104 appearing in FIG. 1 operates.

In the following, operation performed when the user presses the toggle buttons 410 to 412 appearing in FIG. 4 will be mainly described as operations relevant to the present invention.

The process is started in a step S201, and when a mouse event is detected in a step S202, the present process proceeds to a step S203, wherein the CPU 201 first checks whether or not the mouse event is a click on any of the above-mentioned toggle buttons. If the mouse event is not a click on any of the toggle buttons, processing associated with the mouse event is executed (step S206). Description of operations performed in response to the other mouse events is omitted here.

If the mouse event is a click on any of the toggle buttons, the process proceeds to a step S204, wherein the CPU 201 calls a keyboard event API (Application Program Interface) provided by the OS and stores a window capture of its own window in a clipboard.

The clipboard is a memory area in the RAM 203 managed by the OS, and is used for temporary data storage e.g. for copying and pasting. When the capture information on the window of the Web browser 10 is stored in the clipboard, the process proceeds to the following step S205, wherein the CPU 201 refers to browser layout information.

Specifically, the browser layout information is obtained as a result of a layout operation performed by the page display section 103 in the process in FIG. 3. After the CPU 201 has referred to the browser layout information, the process proceeds to a step S207, wherein the CPU 201 calculates which of rectangles in an image currently stored in the clipboard contains a target object. The term “target object” is intended here to mean an object (requiring a plug-in) associated with the clicked toggle button.

Then, in a step S208, the CPU 201 performs processing for clipping (cutting out) the rectangle containing the target object from the window capture stored in the clipboard. This makes it possible to store the image in the area being displayed by the plug-in when the button is pressed, in the RAM 203 (step S209).

The step S209 is an example of the function of a storage unit, in the present invention, that stores images obtained by the clip unit on a dynamic object-by-dynamic object basis. The storage unit stores a plurality of images for the same dynamic object.

Each of the images stored in the RAM 203 is saved as a pointer in the capture object database and is managed by the Web browser 10. This completes the processing to be executed in response to a toggle event, and hence unless the closing of the Web browser is not instructed (step S210), the process returns to the step of awaiting another mouse event.

FIG. 7 is a diagram of an example of the capture object database for use in the step S106 in FIG. 3.

The objects existing in the currently browsed Web page and each requiring a plug-in have all been registered in the capture object database by repeatedly executing the step S106. The capture object database comprises an object ID 701, an object URL 702, an in-canvas rectangle 703, an extension ID 704, and a capture image pointer 705. Each object URL 702 indicates a URL where an associated object exists.

FIG. 7 shows a case where the HTTP absolute path is used for management. However, a relative path may be used for management. Each in-canvas rectangle 703 indicates a rectangular area occupied by an object in the view area 1007 of the present Web browser 10 and is calculated with the upper left vertex of the view area 1007 as the origin.

This information on the rectangle is updated each time re-rendering is performed following re-layout e.g. when the scroll bar 1008 is operated or when the window size is changed. Further, this rectangle information is used to calculate rectangle information on a target object from a window capture image in the clipboard in the step S207 in FIG. 6. In the calculation, the height of a menu bar and that of the toolbar area 1006 are also taken into account.

Each extension ID 704 indicates which of the extensions ID 501 in FIG. 5 is in use, and a used plug-in can be identified by an associated extension ID 704. Each capture image pointer 705 stores the pointer of an image stored in the step S209 in FIG. 6.

When a toggle button associated with an object is clicked, a pointer is stored in a capture image pointer 705 associated with the object, whereas when a toggle button associated with an object has not been clicked yet, “Null” is stored in a capture image pointer 705 associated with the object. These information items are all managed based on the respective associated object IDs 701.

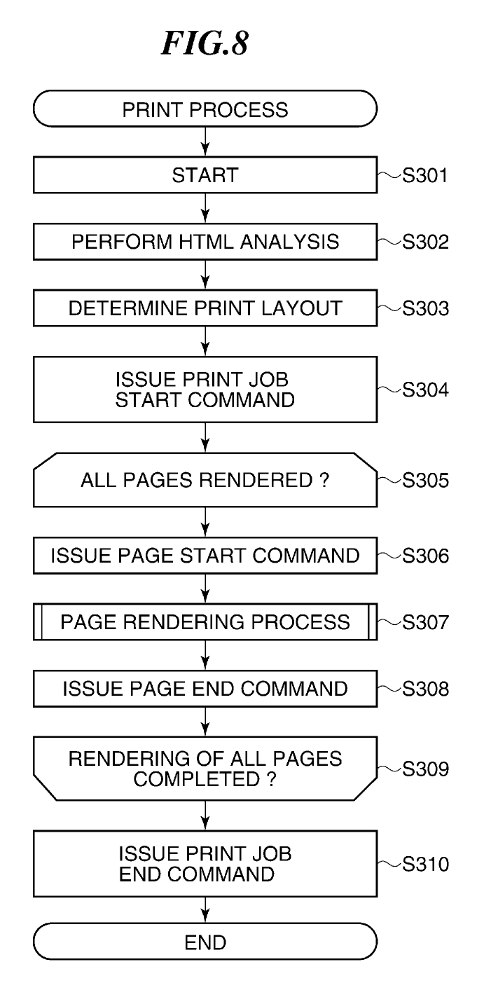

FIG. 8 is a flowchart of a print process executed by the computer 1 in FIG. 1. An actual printing operation is performed by the printer driver 12 of the printer 3.

Printing by the Web browser 10 is performed e.g. when the print button 1005 on the toolbar area 1006 is clicked by the user. When printing is started (step S301), the CPU 201 performs HTML analysis first (step S302) and then determines a print layout (step S303). In layout work, print-target objects in the HTML page are all handled as rectangle information, and each page for a sheet is laid out with the rectangles.

It should be noted that when a tag dedicated to printing is written in the HTML page, layout determination is performed by referring to the tag. Then, in a step S304, the CPU 201 issues a print job start command using the API of the OS.

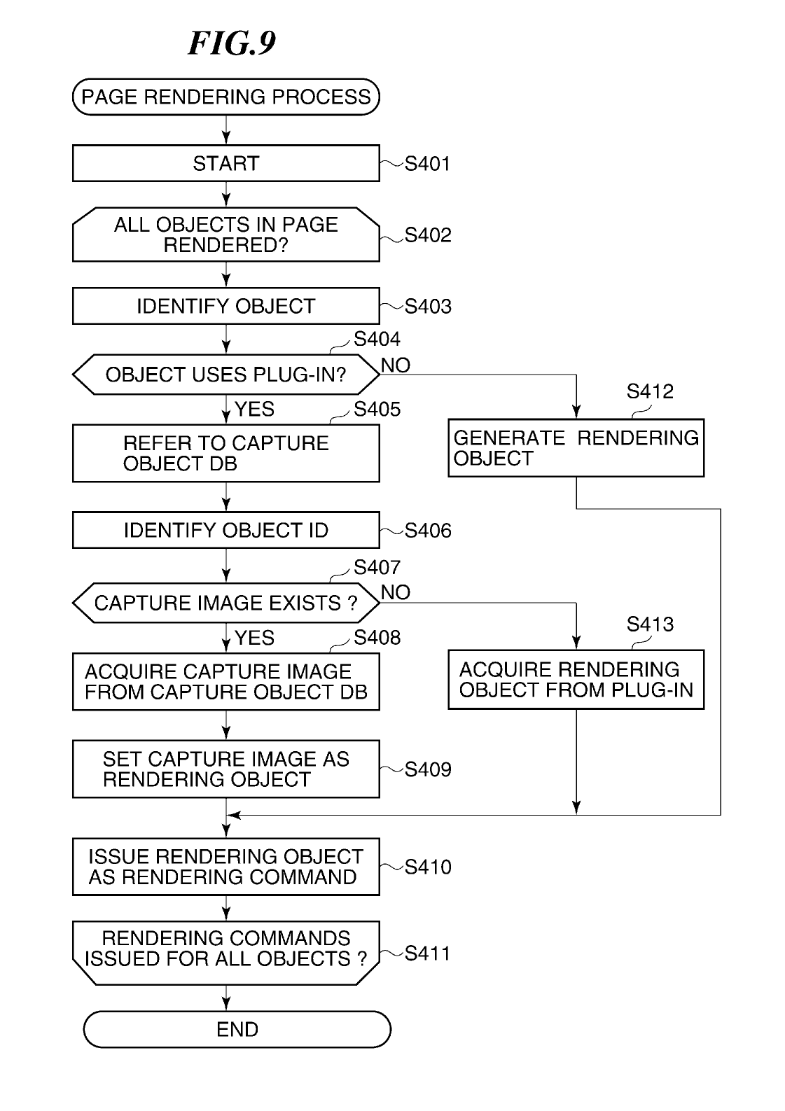

Further, in a step S306, the CPU 201 issues a page start command. Thereafter, in a step S307, the CPU 201 actually renders the objects having undergone layout determination. The rendering process will be described in detail hereinafter with reference to FIG. 9.

When rendering of all objects in a page is completed, the process proceeds to a step S308, wherein the CPU 201 issues a page end command. When rendering of all pages is completed (step S309), the CPU 201 issues a print job end command in a step S310, followed by terminating the print process.

It should be noted that the above-described process is all executed by the Web browser 10 through the API of the OS, and in response to this, the OS gives a print instruction to the printer driver 12 using the graphic engine 11.

FIG. 9 is a flowchart of a page rendering process executed in the step S307 in FIG. 8.

The process is started in a step S401, and the CPU 201 performs the following processing on an object-by-object basis to render all the objects in the page (steps S402 to S411): First, in the step S403, the CPU identifies a type of an object to be printed. Then, in the step S404, the CPU 201 switches processing, depending on whether or not the object uses a plug-in.

The plug-in management database shown in FIG. 5 can be used for this determination as well. If the object does not require a plug-in, a rendering object is generated from the target object as usual (step S412). The term “rendering object” refers to an object having a form interpretable by the graphic engine 11, such as an image object, a graphic object, and a text object.

On the other hand, if the object requires a plug-in, the process proceeds to the step S405, wherein the CPU 201 refers to the capture object database, in the first place. Then, the CPU 201 identifies an object ID based on the content of the object (step S406), and determines, by referring to the associated capture image pointer 705, whether or not a capture image exists (step S407).

If a capture image exists, the CPU 201 acquires the capture image based on the capture image pointer in the capture object database in a step S408, and sets the capture image as a rendering object in a step S409. The step S409 is an example of the function of a generation unit, in the present invention, that generates print data in executing printing by substituting an associated one of the images stored in the storage unit for a print image of a dynamic object.

In this case, the rendering object has an image attribute, and its resolution is equal to the resolution of the display. If no capture image exists, a rendering object is acquired from an associated plug-in in a step S413.

In this case, the rendering object is dependent on the implementation of the plug-in, and it can be envisaged that the rendering object has one of various attributes including a text attribute, a graphic attribute, and an image attribute. In the step S410, the CPU 201 issues the rendering object obtained through the above-described sequence to the OS, as a rendering command. When the CPU 201 has issued rendering commands associated with all the objects in the page (step S411), this terminates the present page rendering process.

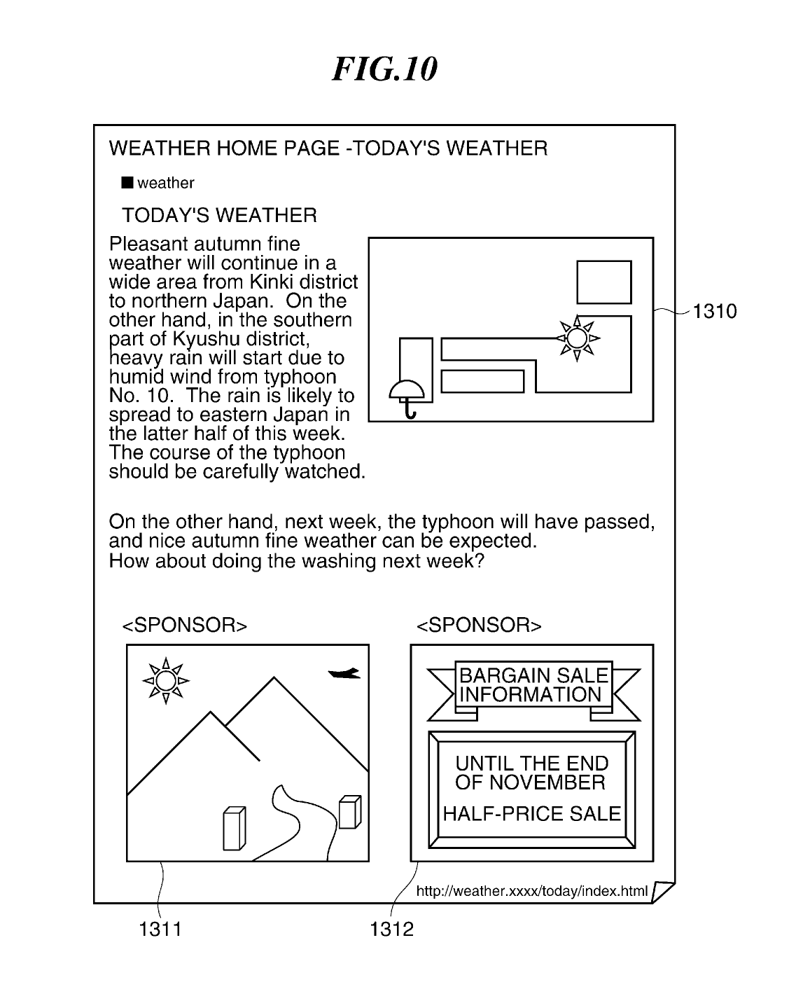

FIG. 10 is a view of an example of a printout from the Web browser 10 appearing in FIG. 1.

The present embodiment makes it possible to designate predetermined moments desired by the user in association with all dynamic objects 1310, 1311, and 1312, so that it is possible to obtain a printout more desired by the user. Further, since the capture function of the OS is used, it is possible to obtain a printout having the same image as viewed on the Web browser, independently of the implementation of the associated plug-ins.

Although in the present embodiment, toggle buttons are employed as capture buttons, it is not absolutely necessary to switch on and off, and therefore another type of buttons which make it possible to perform image capture a plurality of times may be arranged on a Web page.

When image capture is performed a plurality of times, the user may be allowed to select and input images to be used for printing, or a plurality of images may be fitted in a given rectangle, with their image sizes reduced, for printing. In the latter case, the fitting of the reduced images can be realized by performing re-layout of the images in the rectangle in the step S406 in FIG. 9.

In the present embodiment, the description is given, by way of example, of a case where the Web browser performs layout and object image acquisition by itself, for simplicity of explanation. In a case where a layout engine and a rendering engine are additionally used, the present invention can be achieved by substituting results obtained by operation of the engines afterwards to supply the same to the user for printing. When the engines have overridable interfaces, the present invention may be put into practice by utilizing the interfaces.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2009-227129, filed Sep. 30, 2009, which is hereby incorporated by reference herein in its entirety.

What is claimed is:

1. An information processing apparatus comprising:
an instruction unit configured to give an instruction, to each dynamic object of a plurality of dynamic objects contained in a displayed Web page, for specifying an image of the dynamic object in predetermined timing;
a storage unit configured to store the specified image of the dynamic object in the predetermined timing, on a dynamic object basis for each of the plurality of dynamic objects; and
a generation unit configured to generate, when executing printing of the Web page, print data using the images stored by said storage unit without using images being displayed during execution of the printing as print images associated with the respective dynamic objects.

2. The information processing apparatus according to claim 1, wherein said storage unit stores a plurality of images for one of the dynamic objects.

3. The information processing apparatus according to claim 2, wherein said generation unit generates print data using an image formed by combining the plurality of stored images after reducing respective sizes thereof, as a print image associated with the dynamic object.

4. A method of controlling an information processing apparatus, comprising:
giving an instruction, to each dynamic object of a plurality of dynamic objects contained in a displayed Web page, for specifying an image of the dynamic object in predetermined timing;
storing the specified image of the dynamic object in the predetermined timing, on a dynamic object basis for each of the plurality of dynamic objects; and
generating, when executing printing of the Web page, print data using the stored images without using images being displayed during execution of the printing as print images associated with the respective dynamic objects.

5. A non-transitory computer-readable storage medium storing a computer-executable program for causing a computer to execute a method of controlling an information processing apparatus,
wherein the method comprises:
giving an instruction, to each dynamic object of a plurality of dynamic objects contained in a displayed Web page, for specifying an image of the dynamic object in predetermined timing;
storing the specified image of the dynamic object in the predetermined timing, on a dynamic object basis for each of the plurality of dynamic objects; and
generating, when executing printing of the Web page, print data using the stored images without using images being displayed during execution of the printing as print images associated with the respective dynamic objects.
